(19) United States
(12) Patent Application Publication
(10) Pub. No.: US 2023/0086597 A1
(43) Pub. Date: Mar. 23, 2023

(54) INSULATING DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Satoshi AKUTSU, Yokohama (JP); Kazuyuki ITO, Kamakura (JP); Takuo KIKUCHI, Kamakura (JP); Nobuaki MAKINO, Fujisawa (JP); Tatsuya OHGURO, Yokohama (JP); Yoshihiko FUJI, Nakatsu (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 17/814,702

(22) Filed: Jul. 25, 2022

(30) Foreign Application Priority Data
Sep. 17, 2021 (JP) 2021-152281

(51) Int. Cl. H01F 27/32; H01F 27/28; H01F 38/14

(52) U.S. Cl. CPC H01F 27/327; H01F 27/2804; H01F 38/14

(57) ABSTRACT

An insulating device includes a first element, a second element, a first lead, a second lead, and a resin member. The second element is electrically connected to the first element. The first element is mounted on the first lead. The second lead includes a first surface and a second surface, the second surface being at a side opposite to the first surface. The second element is mounted to the first surface. the second lead is arranged to overlap the first element in a direction crossing the second surface of the second lead. The resin member seals the first element, the second element, the first lead, and the second lead.

### CROSS REFERENCE TO RELATED APPLICATIONS

This application is based upon and claims the benefit of priority from Japanese Patent Application No. 2021-152281, filed on Sep. 17, 2021; the entire contents of which are incorporated herein by reference.

### FIELD

Embodiments relate to an insulating device.

### BACKGROUND

The number of semiconductor components is increasing to enable the automatic driving of automobiles and the IoT of household appliance products. However, the mounting space of semiconductor components is not increasing, and downsizing of semiconductor packages is necessary.

### BRIEF DESCRIPTION OF THE DRAWINGS

FIG. 1 is a schematic cross-sectional view showing an insulating device according to an embodiment;

FIGS. 2A and 2B are schematic views showing the insulating device 1 according to the embodiment;

FIGS. 3A to 3D are schematic views showing manufacturing processes of the insulating device according to the embodiment;

FIGS. 4A and 4B are schematic cross-sectional views showing insulating devices according to modifications of the embodiment;

FIG. 5 is a schematic cross-sectional view showing an insulating device according to another modification of the embodiment; and

FIGS. 6A to 6C are schematic views showing an insulating device according to another modification of the embodiment.

### DETAILED DESCRIPTION

According to one embodiment, an insulating device includes a first element, a second element, a first lead, a second lead, and a resin member. The second element is electrically connected to the first element. The first element is mounted on the first lead. The second lead includes a first surface and a second surface, the second surface being at a side opposite to the first surface. The second element is mounted to the first surface. the second lead is arranged to overlap the first element in a direction crossing the second surface of the second lead. The resin member seals the first element, the second element, the first lead, and the second lead.

Embodiments will now be described with reference to the drawings. The same portions inside the drawings are marked with the same numerals; a detailed description is omitted as appropriate; and the different portions are described. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated.

There are cases where the dispositions of the components are described using the directions of XYZ axes shown in the drawings. The X-axis, the Y-axis, and the Z-axis are orthogonal to each other. Hereinbelow, the directions of the X-axis, the Y-axis, and the Z-axis are described as an X-direction, a Y-direction, and a Z-direction. Also, there are cases where the Z-direction is described as upward and the direction opposite to the Z-direction is described as downward.

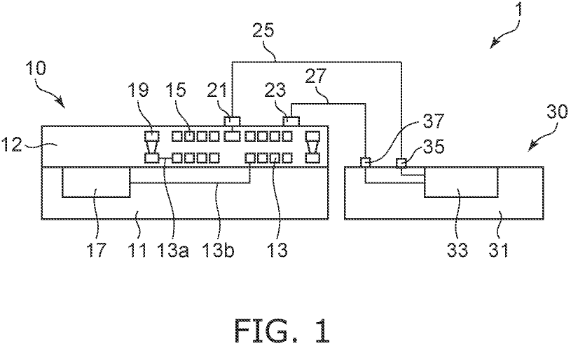

FIG. 1 is a schematic cross-sectional view showing an insulating device 1 according to an embodiment. The insulating device 1 is, for example, a digital isolator. As shown in FIG. 1, the insulating device 1 includes a first element 10 and a second element 30.

The first element 10 includes a semiconductor substrate 11, an insulating member 12, a first coil 13, a second coil 15, a control circuit 17 (an input-side circuit), an external terminal 19, a first connection terminal 21, and a second connection terminal 23.

The semiconductor substrate 11 is, for example, a silicon substrate. The insulating member 12 is provided on the semiconductor substrate 11. The insulating member 12 is, for example, a silicon oxide film. The insulating member 12, for example, has a structure in which multiple insulating films are stacked.

The first coil 13 and the second coil 15 are provided in the insulating member 12. The first coil 13 is provided between the semiconductor substrate 11 and the second coil 15. The first coil 13 and the second coil 15 are electrically insulated from each other by the insulating member 12. The first coil 13 and the second coil 15 are arranged to be magnetically coupled. The first coil 13 and the second coil 15 are, for example, planar coils that are located at facing positions.

The first coil 13 (a primary coil) includes a first end electrically connected to the external terminal 19 via first wiring 13a. The external terminal 19 is connected to a reference potential (e.g., a ground potential) of the primary side. The first coil 13 also includes a second end electrically connected to the control circuit 17 via a second wiring 13b. The control circuit 17 is provided on the semiconductor substrate 11 between the semiconductor substrate 11 and the insulating member 12.

The second coil 15 (a secondary coil) is electrically connected to the first and second connection terminals 21 and 23. The two ends of the second coil 15 are connected respectively to the first and second connection terminals 21 and 23 via, for example, wiring (not-illustrated).

The control circuit 17 provides a primary current to the first coil 13. The primary current flows in the first coil 13 with an input signal superimposed. An induced current (a secondary current) flows in the second coil 15. The secondary current in the second coil 15 corresponds to a magnetic field change due to the primary current flowing through the first coil 13. Thereby, an electrical signal is transmitted between the first coil 13 and the second coil 15 that are electrically insulated from each other.

The second element 30 includes a semiconductor substrate 31, a signal detection circuit 33, a third connection terminal 35, and a fourth connection terminal 37. The third connection terminal 35 and the fourth connection terminal 37 are electrically connected to the signal detection circuit 33. The signal detection circuit 33 is provided at the front side of the semiconductor substrate 31. The third connection terminal 35 and the fourth connection terminal 37, for example, are provided on the same surface as the signal detection circuit 33.

The first element 10 and the second element 30 are electrically connected, for example, via metal wires 25 and 27. The metal wire 25 electrically connects the first connection terminal 21 of the first element 10 and the third connection terminal 35 of the second element 30. The metal wire 27 electrically connects the second connection terminal 23 of the first element 10 and the fourth connection terminal 37 of the second element 30. Thereby, the secondary current of the second coil 15 flows in the signal detection circuit 33, and the electrical signal that is superimposed onto the secondary current is extracted by the signal detection circuit 33.

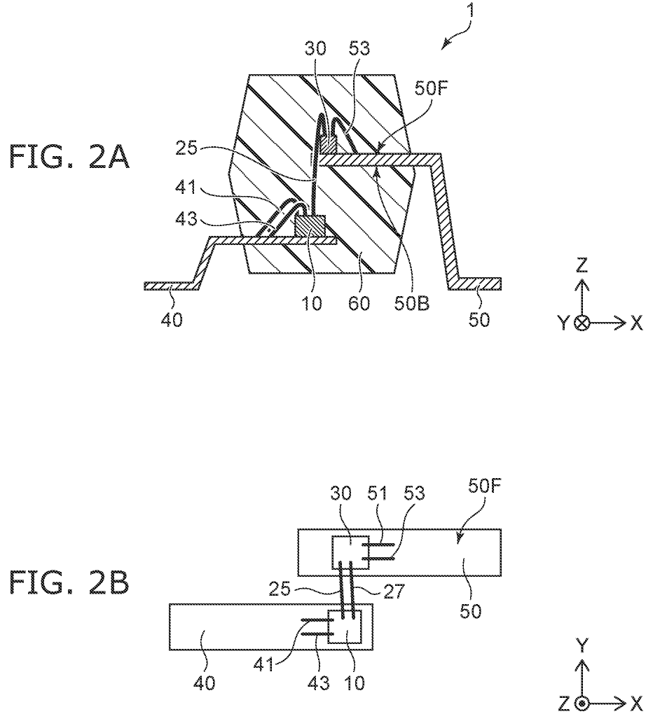

FIGS. 2A and 2B are schematic views showing the insulating device 1 according to the embodiment. FIG. 2A is a schematic cross-sectional view showing the insulating device 1. FIG. 2B is a plan view showing the arrangement of the first and second elements 10 and 30 when viewed from above.

As shown in FIG. 2A, the insulating device 1 further includes a first lead 40, a second lead 50, and a resin member 60. The first lead 40 and the second lead 50 are, for example, metal plates that include copper or aluminum. The resin member 60 is, for example, an epoxy resin.

The first element 10 is mounted on the first lead 40. For example, the first element 10 is electrically connected to the first lead 40 via metal wires 41 and 43.

The second element 30 is mounted on the second lead 50. The second lead 50 includes a first surface 50F and a second surface 50B. The second surface 50B is positioned at the side opposite to the first surface 50F. The second element 30 is mounted on the first surface 50F. For example, the second element 30 is electrically connected to the second lead 50 via a metal wire 53.

As shown in FIG. 2A, the first element 10 is provided below the second element 30. The first element 10 is located at, for example, a position that overlaps the second surface 50B in a direction crossing the second surface 50B of the second lead 50.

As shown in FIG. 2A, the first element 10 is electrically connected to the second element 30 via, for example, the metal wire 25. The metal wire 27 is not illustrated in FIG. 2A.

Thus, the size of the insulating device 1 in an X-direction and a Y-direction can be reduced by including the first element 10 and the second element 30 that are apart in, for example, the vertical direction (a Z-direction).

The resin member 60 seals the first element 10, the second element 30, the first lead 40, and the second lead 50 in the interior of the resin member 60. The first lead 40 and the second lead 50 are provided such that portions of the first and second leads 40 and 50 extend outside from the resin member 60.

As shown in FIG. 2B, for example, the first element 10 and the second element 30 are arranged in the Y-direction in a plane parallel to the first surface 50F of the second lead 50. For example, the first element 10 and the second element 30 are electrically connected via the metal wires 25 and 27. For example, the second element 30 is electrically connected to the second lead 50 via metal wires 51 and 53.

In the example, the second element 30 is provided obliquely above the first element 10. Thereby, the metal wires 25 and 27 can be bonded to the first element 10 and second element 30.

Embodiments are not limited to the examples described above. For example, the second lead 50 and a portion of the first element 30 may overlap in a direction (the Z-direction) perpendicular to the second surface 50B of the second lead 50. In other words, the metal wires 25 and 27 can be bonded as long as the second lead 50 and the bonding pad of the first element 10 do not overlap in a plane parallel to the first surface 50F.

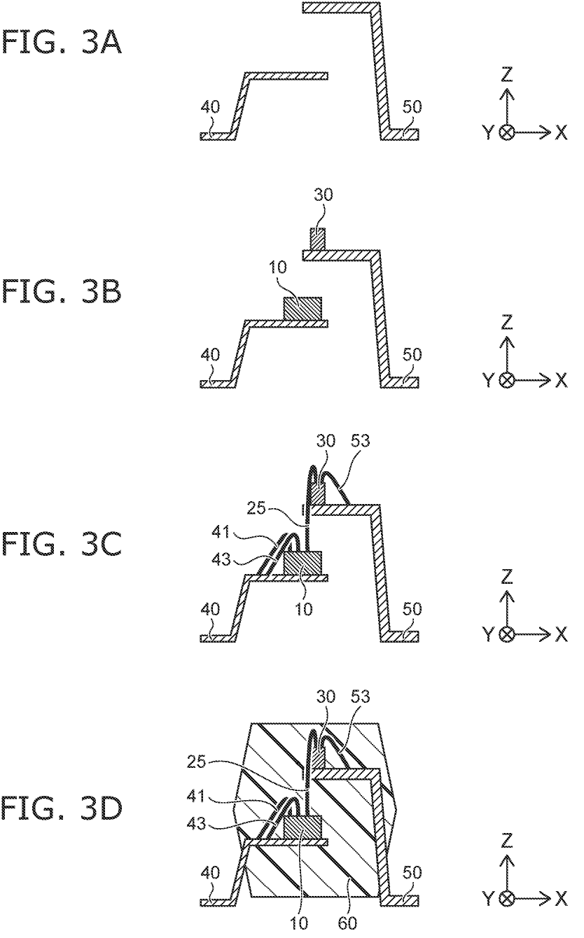

A method for manufacturing the insulating device 1 will now be described with reference to FIGS. 3A to 3D. FIGS. 3A to 3D are schematic views showing manufacturing processes of the insulating device 1 according to the embodiment.

As shown in FIG. 3A, the first lead 40 and the second lead 50 are located at prescribed positions. The first lead 40 and the second lead 50 are included in, for example, one lead-frame (not illustrated).

As shown in FIG. 3B, the first element 10 and the second element 30 are mounted respectively onto the first and second leads 40 and 50. The first element 10 and the second element 30 are mounted via bonding members (not illustrated).

As shown in FIG. 3C, the first element 10 and the second element 30 are electrically connected via the metal wire 25. The metal wire 25 is connected to the first and second elements 10 and 30 by, for example, ultrasonic bonding. The first element 10 is electrically connected to the first lead 40 via the metal wires 41 and 43. The second element 30 is electrically connected to the second lead 50 via the metal wire 53.

As shown in FIG. 3D, the first element 10, the second element 30, the first lead 40, and the second lead 50 are sealed inside the resin member 60. The resin member 60 is formed such that the portions of the first and second leads 40 and 50 extend outward.

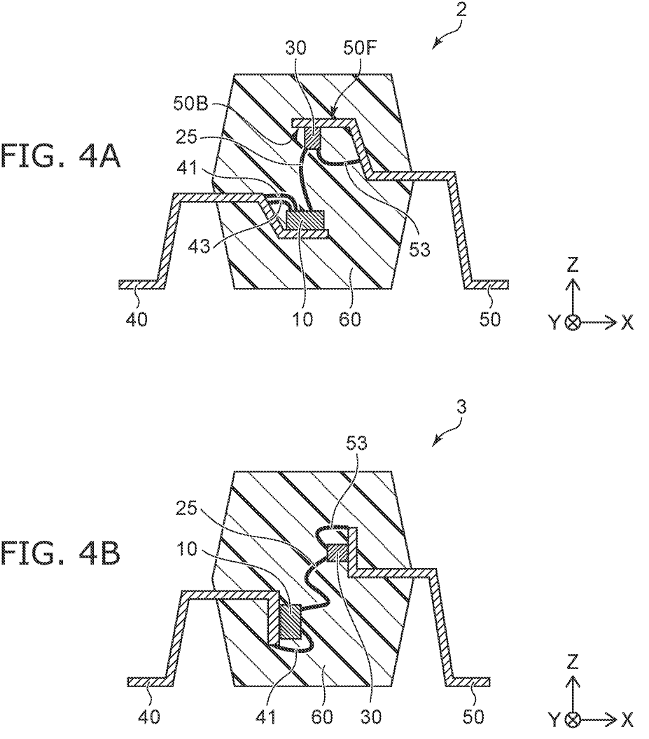

FIGS. 4A and 4B are schematic cross-sectional views showing insulating devices 2 and 3 according to modifications of the embodiment.

In the insulating device 2 shown in FIG. 4A, the second element 30 is mounted to the second surface 50B side of the second lead 50. For example, the first element 10 is located at a position that overlaps the second element 30 in a direction crossing the second surface 50B. The first element 10 and the second element 30 are electrically connected by, for example, the metal wire 25.

In the insulating device 3 as shown in FIG. 4B, the end portions of the first and second leads 40 and 50 are bent respectively in the +Z direction and the -Z direction. The first element 10 is mounted on the side surface of the bent end portion of the first lead 40. The second element 30 is mounted on the side surface of the bent end portion of the second lead 50.

The first element 10 is located at a position that overlaps the second element 30 in a direction crossing the side surface of the second lead 50. The first element 10 and the second element 30 are electrically connected by, for example, the metal wire 25.

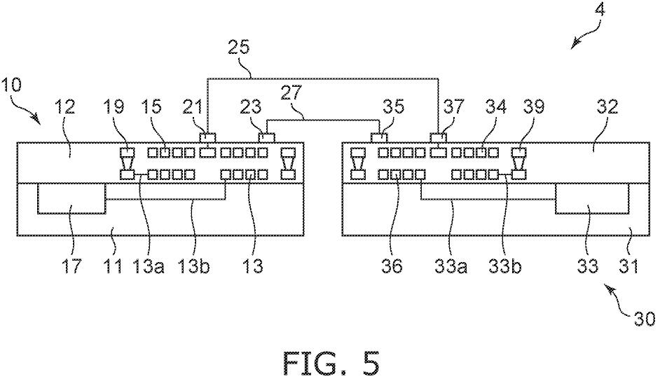

FIG. 5 is a schematic cross-sectional view showing an insulating device 4 according to another modification of the embodiment. In the example, the second element 30 further includes an insulating member 32, a third coil 34 (a primary coil), and a fourth coil 36 (a secondary coil).

The insulating member 32 is provided on the semiconductor substrate 31. The insulating member 32 is, for example, a silicon oxide film. The insulating member 32, for example, has a structure in which multiple insulating films are stacked.

The third coil 34 and the fourth coil 36 are provided in the insulating member 32. The fourth coil 36 is provided between the semiconductor substrate 31 and the third coil 34. The third coil 34 and the fourth coil 36 are electrically insulated from each other by the insulating member 32. The third coil 34 and the fourth coil 36 are arranged to be magnetically coupled. The third coil 34 and the fourth coil 36 are, for example, planar coils that are located at mutually facing positions.

The third coil 34 is electrically connected to the third and fourth connection terminals 35 and 37. The two ends of the third coil 34 are connected respectively to the third and fourth connection terminals 35 and 37, for example, via wiring (not-illustrated).

The fourth coil 36 includes a first end that is electrically connected to an external terminal 39 via fourth wiring 33b. The external terminal 39 is connected to, for example, the reference potential of the secondary side. The fourth coil 36 also includes a second end that is electrically connected to the signal detection circuit 33 (the output-side circuit) via third wiring 33a. The signal detection circuit 33 is provided on the semiconductor substrate 31 between the semiconductor substrate 31 and the insulating member 32.

The secondary current of the second coil 15 flows in the third coil 34 via the metal wires 25 and 27. An induced current (a tertiary current) flows in the fourth coil 36. The tertiary current corresponds to the magnetic field change due to the secondary current in the third coil 34. Thereby, an electrical signal is transmitted between the third coil 34 and the fourth coil 36 that are electrically insulated from each other. The signal detection circuit 33 detects the electrical signal included in the tertiary current and outputs the electrical signal to an external circuit (not illustrated).

In the insulating device 4, the electrical signal is transmitted via the first coil 13, the second coil 15, the third coil 34, and the fourth coil 36. Thus, by adding the third coil 34 and the fourth coil 36 to the transmission path of the electrical signal, the breakdown voltage between the first coil 13 and the fourth coil 36 can be 2 times the breakdown voltage between the first coil 13 and the second coil 15.

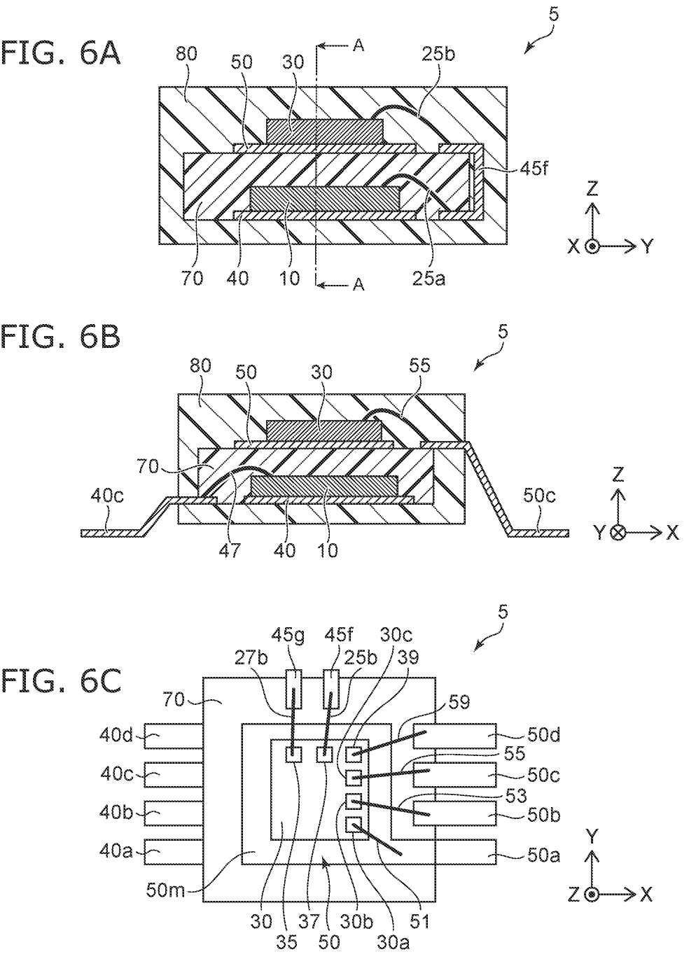

FIGS. 6A to 6C are schematic views showing an insulating device 5 according to another modification of the embodiment. FIG. 6A is a cross-sectional view of the insulating device 5. FIG. 6B is a cross-sectional view along line A-A shown in FIG. 6A. FIG. 6C is a plan view showing the upper surface of the insulating device 5.

As shown in FIG. 6A, the first element 10 is mounted on the first lead 40 and sealed with a first resin member 70 (an internal mold resin). The second lead 50 is provided on the first resin member 70. The second lead 50, for example, is placed on the first resin member 70. The second element 30 is mounted on the second lead 50.

In the example, the second element 30 is positioned above the first element 10. The second element 30 is electrically connected to the first element 10, for example, via a metal wire 25a, a third lead 45f, and a metal wire 25b.

The first resin member 70 includes an upper surface to which the second lead 50 is mounted, a lower surface at the side opposite to the upper surface, and a side surface that links the upper surface and the lower surface. The third lead extends along the side surface of the first resin member 70, and includes a first end that is positioned in the first resin member 70 and a second end that is positioned at the upper surface of the first resin member 70.

The first element 10 is electrically connected to the first end of the third lead 45f via the metal wire 25a. The second element 30 is electrically connected to the second end of the third lead 45f via the metal wire 25b.

A leadframe (not illustrated) that includes the first and third leads 40 and 45f is used in the manufacturing processes of the insulating device 5. The first element 10 is mounted on the first lead 40. Subsequently, the first element 30 and the third lead 45f are electrically connected by bonding the metal wire 25a to the first element 30 and the third lead 45f. Continuing, the first resin member 70 is formed to seal the first element 10, the metal wire 25a, and the portion of the third lead 45f to which the metal wire 25a is bonded. The third lead 45f is sealed so that a portion of the third lead 45f extends outside from the first resin member 70. Subsequently, the third lead 45f is separated from the leadframe (not illustrated); and the portion of the third lead 45f extending from the first resin member 70 is formed to extend from the side surface to the upper surface of the first resin member 70.

Another leadframe (not illustrated) that includes the second lead 50 is provided over the leadframe including the first element 10 and the first lead 40 sealed by the first resin member 70. Then, the second lead 50 is placed on the first resin member 70. Subsequently, the second element 30 is mounted on the second lead 50. At the upper surface side of the first resin member 70, the second element 30 and the third lead 45f are electrically connected by bonding the metal wire 25b to the second element 30 and the third lead 45f. Continuing, a second resin member 80 (an external mold resin) is formed to seal the second element 30, the second lead 50, the third lead 45f, the metal wire 25b, and the first resin member 70.

As shown in FIG. 6B, the insulating device 5 further includes a primary terminal 40c and a secondary terminal 50c that extend outside from the second resin member 80. For example, the primary terminal 40c extends into the first resin member 70 and is electrically connected to the first element 10 via a metal wire 47. The secondary terminal 50c extends into the second resin member 80 and is electrically connected to the second element 30 at the upper surface side of the first resin member 70. The secondary terminal 50c is electrically connected to the second element 30 via a metal wire 55.

FIG. 6C is a plan view showing the upper surface of the first resin member 70 before forming the second resin member 80. As shown in FIG. 6C, the insulating device 5 includes primary terminals 40a to 40d, secondary terminals 50a to 50d, a third lead 45g, and another third lead 45f. The primary terminals 40a to 40d extend outside from the first resin member 70 and also extend outside from the second resin member 80. The primary terminals 40a to 40d are electrically connected to the first element 10 (see FIG. 6B). The secondary terminal 50a extends outside from the second resin member 80 (see FIG. 6B).

As shown in FIG. 6C, the second element 30 includes, for example, bonding pads 30a to 30c, the third connection terminal 35, the fourth connection terminal 37, and the external terminal 39. The second lead 50 includes, for example, a mount bed 50m and the secondary terminal 50a. The second element 30 is mounted on the mount bed 50m of the second lead 50.

The bonding pad 30a is electrically connected to the second lead 50 via the metal wire 51. A bonding pad 30b is connected to a secondary terminal 50b via the metal wire 53. The bonding pad 30c is connected to the secondary terminal 50c via the metal wire 55.

The third connection terminal 35 is electrically connected to the third lead 45g via a metal wire 27b. The third connection terminal 35 is electrically connected to the first element 10 via the third lead 45g (see FIG. 6A). The fourth connection terminal 37 is electrically connected to the third lead 45f via the metal wire 25b. The external terminal 39 is electrically connected to the secondary terminal 50d, for example, via a metal wire 59.

Thus, by using the third leads 45g and 45f, the second element 30 can be provided on the first element 10. The size of the insulating device 5 in the X-direction and the Y-direction can be reduced thereby. At least one of the first element 10 or the second element 30 includes a primary coil and a secondary coil magnetically coupled to the primary coil.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An insulating device, comprising:
a first element;
a second element electrically connected to the first element;
a first lead, the first element being mounted on the first lead;
a second lead including a first surface and a second surface, the second surface being at a side opposite to the first surface, the second element being mounted to the first surface, the second lead being arranged to overlap the first element in a direction crossing the second surface of the second lead; and
a resin member sealing the first element, the second element, the first lead, and the second lead.

2. The device according to claim 1, wherein
the first element includes a first coil and a second coil magnetically coupled to the first coil, and
the second element includes a terminal and an output-side circuit, the terminal being electrically connected to the second coil, the output-side circuit detecting an electrical signal transmitted via the first and second coils.

3. The device according to claim 2, wherein
the terminal of the second element is electrically connected to the second coil of the first element via a metal wire.

4. The device according to claim 2, wherein
the terminal of the second element is electrically connected to the output-side circuit.

5. The device according to claim 2, wherein
the first element further includes a first substrate and a first insulating member provided on the first substrate, the first coil and the second coil being provided in the first insulating member.

6. The device according to claim 5, wherein
the first element further includes a secondary terminal provided on the first insulating member and electrically connected to the second coil,
the first coil is provided between the first substrate and the second coil, and
the secondary terminal is electrically connected to the terminal of the second element via a metal wire.

7. The device according to claim 2, wherein
the first element further includes an input-side circuit electrically connected to the first coil.

8. The device according to claim 7, wherein
the first coil includes first and second ends, the first end being connected to a reference potential of a primary side, the second end being electrically connected to the input-side circuit.

9. The device according to claim 7, wherein
the first element further includes a first substrate and a first insulating member provided on the first substrate,
the first coil and the second coil being provided in the first insulating member,
the input-side circuit being provided on the first substrate between the first substrate and the first insulating member.

10. The device according to claim 2, wherein
the second element further includes a second substrate, the output-side circuit and the terminal being provided on the second substrate.

11. The device according to claim 2, wherein
the second element further includes third and fourth coils, the third coil being electrically connected to the terminal, the fourth coil being magnetically coupled to the third coil and electrically connected to the output-side circuit.

12. The device according to claim 11, wherein
the second element further includes a second substrate and a second insulating member provided on the second substrate,
the output-side circuit being provided on the second substrate between the second substrate and the second insulating member,
the third coil and the fourth coil being provided in the second insulating member,
the terminal being provided on the second insulating member.

13. The device according to claim 12, wherein
the fourth coil is provided between the second substrate and the third coil.

14. The device according to claim 12, wherein
the fourth coil includes first and second ends, the first end being connected to a reference potential of a secondary side, the second end being electrically connected to the output-side circuit.

15. The device according to claim 1, wherein
the resin member includes an internal mold resin and an external mold resin,
the internal mold resin sealing the first element mounted on the first lead,
the external mold resin sealing the second lead provided on the internal mold resin and the second element mounted on the second lead.

16. The device according to claim 15, further comprising:
a third lead electrically connecting the first element and the second element,
the internal mold resin including an upper surface, a lower surface and a side surface, the lower surface being at a side opposite to the upper surface, the side surface linking the upper surface and the lower surface, the second lead being placed to the upper surface,
the third lead extending along the side surface of the internal mold resin, the third lead including first and second ends, the first end of the third lead being positioned in the internal mold resin, the second end of the third lead being positioned at the upper surface of the internal mold resin,
the first element being electrically connected to the first end of the third lead via a metal wire,
the second element being electrically connected to the second end of the third lead via another metal wire,
the external mold resin sealing the internal mold resin, the second element, and the first to third leads.

17. The device according to claim 15, further comprising:
a first connection lead electrically connected to the first element in the internal resin member, the first connection lead including a portion extending outside from the external mold resin; and
a second connection lead electrically connected to the second element in the external resin member, the second connection lead including a portion extending outside from the external mold resin.

18. The device according to claim 15, wherein
at least one of the first element or the second element includes a primary coil and a secondary coil magnetically coupled to the primary coil.
